(19) United States
(12) Patent Application Publication
(10) Pub. No.: US 2004/0245490 A1
(43) Pub. Date: Dec. 9, 2004

(54) Top coating composition for leather

(76) Inventors: Holger Schopke, Neckargemund (DE); Stefan Adams, Ludwigshafen (DE); Helfried Scheidl, Friedelsheim (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/488,106

(22) PCT Filed: Sep. 9, 2002
(86) PCT No.: PCT/EP02/10088

(30) Foreign Application Priority Data
Sep. 28, 2001 (JP) 2001-299972

(51) Int. Cl. C14C 9/00

(52) U.S. Cl. 252/8.57; 524/507; 524/556; 526/303.1; 526/317.1; 526/319

(57) ABSTRACT

A top coating composition for leather comprises

(a) from 20 to 60% by weight of at least one dispersed copolymer A formed from

(a1) from 40 to 70% by weight of at least one ester A1 of methacrylic acid with C₁₋₈-alkanols,

(a2) from 25 to 60% by weight of at least one ester A2 of acrylic acid with C₁₋₈-alkanols,

(a3) from 0 to 3.5% by weight of at least one C₃-C₆ α,β-monoethylenically unsaturated carboxylic acid A3,

(a4) from 0 to 4% by weight of at least one further auxiliary monomer A4 such as hydroxypropyl acrylate, ureidomethacrylate, acrylamide, methacrylamide, N-methylolacrylamide, N-methylolmethacrylamide, A1, A2 and optionally A3 and/or A4 adding up to a total of 100% by weight,

(b) at least 40% by weight of water (B),

(c) from 0 to 40% by weight of polyurethane top coating composition C for leather, A, B and optionally C adding up to a total of 100% by weight and the top coating composition being free of plasticizers and synthetic waxes.

The present invention relates to a top coating composition for leather, a process for its preparation and its use and also correspondingly topcoated leather.

Leather finishes are customarily constructed of three coats. The first coat is the base coat, which consists of pigments, binders and auxiliaries to adhere the entire finish system. The second coat is the actual finish, which is usually somewhat harder than the base coat. It confers the desired appearance and levels on the leather surface. The third coat is the topcoat. It determines the ultimate appearance and also the hand of the leather surface and decisively influences the fastness properties of the entire finish system. Known methods for applying the coats include spraying, casting, printing and laminating as well as the various kinds of coating.

The third layer frequently utilizes solvent based nitrocellulose solutions or water based polyurethane or nitrocellulose emulsions, cf. Ullmann's Encyclopedia of Industrial Chemistry, Sixth Edition, 1998 Electronic Release, chapter “Leather-Finishing and Coating (Eckhardt Heidemann)”, section 11.1. There it is stated that the top coat determines the ultimate properties of the leather. The top coat should be as hard and compact as possible in order that the desired rubfastness may be provided, but should on the other hand be as soft as necessary so that the leather may flex and stretch without breaking. Some top coats contain additives based on silicon dioxide or wax for specific delustering effects.

As well as for the hand and the appearance of the leather surface, the top coat is responsible for the resistance to mechanical influences, water and dust.

Leather finish systems frequently utilize (meth)acrylate based polymer dispersions, since they have a good cost/benefit ratio and release minimal amounts of volatile organic compounds in use. Polyacrylate based polymer products have hitherto been used for impregnating and base coating and as finish layer.

EP-A-0 437 742 concerns aqueous polymer formulations particularly useful as binders for coatings on leather or leather replacement materials. The formulations in question do not contain any additionally crosslinking agents or metal ions and are composed of two different poly(meth)acrylate dispersions which bear free carboxylic acid groups. The compositions further comprise external plasticizers, emulsifiers and water. They may additionally comprise polyurethanes and waxes.

They do not fully meet present day requirements of low VOC polymer formulations.

EP-A-0 563 819 concerns processes for treating leather. Products comprising (meth)acrylate based graft polymers are used. It is stated therein that poly(meth)acrylate based polymer products are used not only for impregnating and base coating but recently increasingly also for top lacquering leathers. The graft polymers used preferably utilize grafting bases based on ethyl acrylate, butyl acrylate and 2-ethylhexyl acrylate, which are preferably grafted with ethyl, butyl and isobutyl methacrylates. The already coated leather is preferably heat treated between 60 and 120° C.

Graft polymers are inconvenient and costly to make.

It is desirable in all phases of leather finishing that the requisite binders may be applied in simple processes and ideally without solvents and with few crosslinking components, if any. The goal is that in general the final finishing operation should employ just a single binder, for example in the case of shoe upper leather, and that further additives for enhanced quality requirements should be needed just in specific cases of severe surface exposure of the leather, for example in the case of automotive upholstery leather.

It is an object of the present invention to provide an aqueous low VOC or solvent free top coating composition based on (meth)acrylate copolymer that fully meets present day quality requirements of a final coat on leather and avoids the disadvantages of known top coating compositions. It shall be coatable onto the first two coats of a leather finish system (base coat and finish coat) by conventional methods and shall bond securely to the undercoat. The top coating composition shall be able to replace the familiar nitrocellulose emulsions in whole or in part without leather surface quality being comprimised.

In addition, the top coating composition shall preferably be compatible, i.e., miscible, with polyurethane top coating compositions over a wide range of proportions.

We have found that this object is achieved by a leather top coating composition comprising

(a) from 20 to 60% by weight of at least one dispersed copolymer A formed from

(a1) from 55 to 70% by weight of at least one ester A1 of methacrylic acid with C₁₋₈-alkanols,

(a2) from 25 to 40% by weight of at least one ester A2 of acrylic acid with C₁₋₈-alkanols,

(a3) from 0.5 to 2% by weight of at least one C₃-C₆ α,β-monoethylenically unsaturated carboxylic acid A3,

(a4) from 0.1 to 2% by weight of at least one further auxiliary monomer A4 such as hydroxypropyl acrylate, ureidomethacrylate, acrylamide, methacrylamide, N-methylolacrylamide, N-methylolmethacrylamide,

A1, A2 and optionally A3 and A4 adding up to a total of 100% by weight,

(b) at least 40% by weight of water (B),

(c) from 0 to 40% by weight of polyurethane top coating composition C for leather,

A, B and optionally C adding up to a total of 100% by weight and the top coating composition being free of plasticizers and synthetic waxes.

The inventors have found that (meth)acrylate copolymers which cast into brittle and inelastic films from aqueous dispersion at room temperature possess an outstanding performance profile when used as a top coat in the finishing of leather. They provide in particular balanced quality performance profile results with regard to hand, smoothness, luster, scratch resistance, wet and dry rubfastness and flex. Especially shoe upper leather finish requirements are all met in full. The top coating compositions of the invention hence constitute a fully adequate replacement for nitrocellulose lacquers, the use of which has hitherto been unavoidable despite the VOC problem.

The top coating compositions according to the invention may advantageously be used for manufacturing high ticket and high quality leathers for the furniture or automotive upholstery leather market, say, in that they may be blended or combined with the polyurethane binders and crosslinkers used there without reductions in quality.

The top coating compositions according to the invention are in fact blendable with commercially available polyurethane top coats over a wide range of proportions. Blends of for example 50 parts:50 parts solid on solid provide similar rubfastnesses and flexometer values to the straight polyurethane top coats. In fact, by using the top coating compositions of the invention in combination with polyurethane binders it is possible to enhance the luster of the final coat.

Polyurethane binders are occasionally also used with crosslinkers, for example crosslinkers containing isocyanate groups, to meet the highest requirements in surface finishing. When used in combination with the top coating compositions of the invention, the same crosslinker quantities can be used in terms of the solids content—whatever the fraction of copolymers A used according to the invention.

The top coating compositions according to the invention are superior to the graft polymers known from EP-A-0 563 819 in terms of property profile for top coats. Compared to EP-A-0 437 742, the VOC problem can be avoided and the compatibility with other systems was improved.

The copolymer A used according to the invention is preferably polymerized from

a1) from 55 to 70% by weight of methyl methacrylate or methyl methacrylatelbutyl methacrylate,

a2) from 40 to 25% by weight of butyl acrylate or butyl acrylate/ethyl acrylate,

a3) from 0.5 to 2% by weight of acrylic acid or methacrylic acid, and

a4) from 0.1 to 2% by weight of acrylamide or methacrylamide.

The dispersed copolymer A may be polymerized in one or more phases. To this end, it may be prepared according to known emulsion polymerization processes or step polymerization processes. Suitable processes are described in the accompanying examples [copolymer A as per Preparation Examples 1 to 6].

The property profile of the top coat is influenced by the composition of copolymer A. By choosing the emulsion feed stream addition procedure or a stepwise procedure in the copolymerization it is possible to adjust the luster and transparency of the top coat. The other properties such as wet and dry rubfastness and the flexometer values, however, are less influenced by the choice of procedure. For lustrous, transparent top coats it is advantageous to use a stepwise procedure.

The copolymer A prepared in one step preferably has a glass transition temperature of from +20° C. to 60° C.

It is particularly preferable for two DSC transitions to be found in the ranges from 20 to 40° C. and from 60 to 120° C. when operating according to a two step procedure. The transitions are particularly preferably located at about 30° C. and in the range from 100 to 110° C.

Copolymer A may additionally be prepared using a crosslinker. Useful crosslinkers include for example butanediol diacrylate or allyl methacrylate in step 1 or N-methylolacrylamide or N-methylolmethacrylamide in steps 1 and 2. However, the use of a crosslinker may also be dispensed with. This also applies in the case of bi- or more highly phasic copolymers A.

Copolymer A exhibits very good miscibility with polyurethane top coats without the need for the presence of groups that are crosslinkable with polyurethanes. The copolymers A can exhibit the inventive advantages in combination with polyurethanes without crosslinking agents having to be used for either component.

The dispersed copolymers A used according to the invention preferably form a hard film when applied to a glass plate. Combination with polyurethanes consequently results in medium and hard phases.

The top coating compositions according to the invention may further comprise from 0 to 15% by weight of a polyurethane crosslinker D based on polyfunctional isocyanates, prepared for example on the basis of hexamethylene 1,6-diisocyanate having up to about 15% of reactive isocyanate groups, and/or from 0 to 15% by weight of an aziridine crosslinker E of the trimethylolpropane tris(beta-aziridino) propionate type. The top coating composition may also be free of these crosslinkers.

We have found that the copolymers A used in the top coating compositions of the invention provide outstanding top coat quality performance even though their cast films are brittle and minimally elastic, if at all.

The invention also provides for the use of the above-described copolymers A as a top coat for leather. The invention further provides for the use of the described top coating compositions for surface treating leather.

The top coating compositions are preparable according to the invention for example by emulsion or step polymerization of the monomers A1, A2 and optionally A3 to form an aqueous dispersion of the copolymer A and optional admixture with the polyurethane top coating composition C.

The polyurethane top coat is a polyurethane in the form of an aqueous dispersion as widely used in leather finishing for some years now, for example the dispersion of a reaction product of polyester polyols [reaction product of aliphatic alcohols, for example neopentylglycol and 1,6-hexanediol, and aliphatic dicarboxylic acids, for example adipic acid] with dimethylolpropionic acid/triethylamine, diethylene-triamine and isophorone diisocyanate.

Delustering effects may be had by adding an opacifier, (for example Aerosil® TS 100).

Also highly suitable are reaction products with the same polyester polyol, isophorone diisocyanate, dicyclohexylmethane diisocyanate, 1,5-pentanediol and sodium 2-aminoethyl-aminoethanecarboxylate dispersed in water.

Exclusive use of the top coating composition according to the invention meets the requirements of apparel and shoe upper leather. All requisite fastnesses are achieved using crosslinkers with or without co-use of polyurethane top coat components. Even without the use of crosslinkers, the fastness level attained is very predominantly good.

The invention accordingly provides an inexpensive top coating composition meeting the requirements set out at the beginning. It may wholly or partly replace the familiar top coating compositions, especially polyurethane based top coating compositions.

The incorporation of small amounts of auxiliary monomers in copolymers A and the addition of customary isocyanate crosslinkers are options to further improve the rubfastnesses.

The examples hereinbelow illustrate the invention.

Preparation of inventive copolymer dispersions A

### EXAMPLE 1a

| Initial charge | |
|---|---|
| comprising | |
| 400.0 | Parts by weight of DM water |
| 13.6 | Parts by weight of a seed latex |
| | (30% in water; particle size 20-40 run) |
| 6.0 | Parts by weight of ethylhexyl thioglycolate |
| Feed stream 1: | |
| 335.0 | Parts by weight of DM water |
| 1.2 | Parts by weight of sodium pyrophosphate |
| 7.2 | Parts by weight of di(2-ethylhexyl) |
| | succinate sulfonate, 50% in water |
| 4.3 | Parts by weight of sodium lauryl ether |
| | sulfate (with 3-7 EO) 28% in water |
| 12.0 | Parts by weight of acrylamide 50% in water |
| 12.0 | Parts by weight of acrylic acid |
| 402.0 | Parts by weight of methyl methacrylate |
| 180.0 | Parts by weight of n-butyl acrylate |
| 12.0 | Parts by weight of hydroxyethyl acrylate |
| Feed stream 2: | |
| 100.0 | Parts by weight of DM water |
| 1.8 | Parts by weight of sodium persulfate |

### Procedure

Purge initial charge in polymerization vessel with nitrogen and heat to 85° C. Then start feed stream 1 and feed stream 2. Feed stream 1 is added over 180 minutes and stream 2 over 195 minutes. This is followed by supplementary polymerization for 30 minutes.

Residual monomers are then removed by customary chemical or physical deodorization. After cooling to room temperature, the dispersion is adjusted to pH 8 with about 4 parts by weight of triethylamine.

The dispersion obtained has a solids content of about 40%. It forms a film which is free of gel specks and hard and brittle after complete drying, and its glass transition temperature is found to be in the range from 45° C. to 50° C. The size of the dispersion particles is below 200 nm. The Brookfield viscosity of the dispersion is in the range from 20 to 100 mPa.s.

### EXAMPLE 2

| Initial charge | |
|---|---|
| comprising | |
| 800.0 | Parts by weight of DM water |
| 27.2 | Parts by weight of a seed latex |
| | (30% in water; particle size 20-40 nm) |
| 12.0 | Parts by weight of ethylhexyl thioglycolate |
| stream 1a: | |
| 500.0 | parts by weight of DM water |
| 2.4 | parts by weight of sodium pyrophosphate |
| 10.8 | parts by weight of di(2-ethylhexyl) |
| | succinate sulfonate, 50% in water |
| 6.4 | parts by weight of sodium lauryl ether |
| | sulfate (with 3-7 EO) 28% in water |
| 9.6 | parts by weight of acrylamide 50% in water |
| 9.0 | parts by weight of acrylic acid |
| 24.0 | parts by weight of hydroxyethyl acrylate |
| 528.0 | parts by weight of methyl methacrylate |
| 337.2 | parts by weight of n-butyl acrylate |
| stream 1b: | |
| 170.0 | parts by weight of DM water |
| 3.6 | parts by weight of di(2-ethylhexyl) |
| | succinate sulfonate, 50% in water |
| 2.1 | parts by weight of sodium lauryl ether |
| | sulfate (with 3-7 EO) 28% in water |
| 9.0 | parts by weight of acrylic acid |
| 288.0 | Parts by weight of methyl methacrylate |
| stream 2: | |
| 200.0 | parts by weight of DM water |
| 3.6 | parts by weight of sodium persulfate |

### Procedure

Purge initial charge in polymerization vessel with nitrogen and heat to 85° C. Then start feed stream 1a and feed stream 2. Stream la is added over 135 minutes and stream 2 over 195 minutes. When stream 1a ends immediately add stream 1b over 45 minutes. This is followed by 30 minutes of supplementary polymerization.

Residual monomers are then removed by customary chemical or physical deodorization. After cooling to room temperature, the dispersion is adjusted to pH 8 with about 12 parts by weight of triethylamine.

The dispersion obtained has a solids content of about 40%. It forms a film which is free of gel specks and hard and brittle after complete drying. The glass transition temperature is found to be 34° C. and there is only a suggestion in the DSC diagram of a second glass transition stage in the region of 100° C. The size of the dispersion particles is below 200 nm. The Brookfield viscosity of the dispersion is in the range from 20 to 100 mPa.s.

### EXAMPLE3

| Initial charge | |
|---|---|
| comprising | |
| 400.0 | parts by weight of DM water |
| 14.4 | parts by weight of tallow fat alcohol |
| | reacted with 18 mol of EO, 20% in water |
| 6.0 | parts by weight of sodium lauryl sulfate |
| | (with 3-7 EO) 15% in water |
| 23.0 | parts by weight of stream la |
| 15.0 | parts by weight of stream 2 |
| Feed stream 1a: | |
| 180.0 | parts by weight of DM water |
| 1.2 | parts by weight of sodium pyrophosphate |
| 21.6 | parts by weight of tallow fat alcohol |
| | reacted with 18 mol |
| | of EO, 20% in water |
| 76.0 | parts by weight of sodium lauryl sulfate |
| | (with 3-7 EO) 15% in water |
| 4.8 | parts by weight of acrylamide 50% in water |
| 4.5 | parts by weight of acrylic acid |
| 2.0 | parts by weight of hydroxyethyl acrylate |
| 3.0 | parts by weight of butanediol diacrylate |
| 270.0 | parts by weight of methyl methacrylate |
| 159.0 | parts by weight of n-butyl acrylate |
| Feed stream 1b: | |
| 55.0 | parts by weight of DM water |
| 21.6 | parts by weight of tallow fat alcohol |
| | reacted with 18 mol of EO, 20% in water |
| 7.6 | parts by weight of sodium lauryl sulfate |
| | (with 3-7 EO) 15% in water |
| 4.5 | parts by weight of acrylic acid |
| 153.0 | parts by weight of methyl methacrylate |
| Feed stream 2: | |
| 100.0 | parts by weight of DM water |
| 1.8 | parts by weight of sodium persulfate |

### Procedure

Purge initial charge comprising water and emulsifiers in polymerization vessel with nitrogen and heat to 85° C. At initial charge 80° C add stream la and stream 2 and allow to incipiently polymerize for 10 minutes. Then start stream 1a and stream 2. Add stream 1a over 135 minutes and stream 2 over 195 minutes. When stream 1a ends immediately add stream 1b over 45 minutes. This is followed by 30 minutes of supplementary polymerization.

Residual monomers are then removed by customary chemical or physical deodorization. After cooling to room temperature, the dispersion is adjusted to pH 8 with about 6.5 parts by weight of triethylamine.

The dispersion obtained has a solids content of about 40%. It forms a film which is free of gel specks and hard and brittle after complete drying. The glass transition temperature is found to be 25° C. and there is only a suggestion in the DSC diagram of a second glass transition stage in the region of 100° C. The size of the dispersion particles is below 100 nm. The Brookfield viscosity of the dispersion is in the range from 30 to 100 mPa.s.

### EXAMPLE4

| Initial charge | |
|---|---|
| comprising | |
| 400.0 | parts by weight of DM water |
| 14.4 | parts by weight of tallow fat alcohol |
| | reacted with 18 mol of EO, 20% in water |
| 6.0 | parts by weight of sodium lauryl sulfate |
| | (with 3-7 EO) 15% in water |
| 23.0 | parts by weight of stream 1a |
| 15.0 | parts by weight of stream 2 |
| Feed stream 1a: | |
| 180.0 | parts by weight of DM water |
| 1.2 | parts by weight of sodium pyrophosphate |
| 21.6 | parts by weight of tallow fat alcohol |
| | reacted with 18 mol |
| | of EO, 20% in water |
| 76.0 | parts by weight of sodium lauryl sulfate |
| | (with 3-7 EO) 15% in water |
| 4.8 | parts by weight of acrylamide 50% in water |
| 4.5 | parts by weight of acrylic acid |
| 2.0 | parts by weight of hydroxyethyl acrylate |
| 270.0 | parts by weight of methyl methacrylate |
| 159.0 | parts by weight of n-butyl acrylate |
| Feed stream 1b: | |
| 55.0 | parts by weight of DM water |
| 21.6 | parts by weight of tallow fat alcohol |
| | reacted with 18 mol of EO, 20% in water |
| 7.6 | parts by weight of sodium lauryl sulfate |
| | (with 3-7 EO) 15% in water |
| 14.5 | parts by weight of methylol-methacrylamide |
| 145.0 | Parts by weight of methyl methacrylate |
| Feed stream 2: | |
| 100.0 | parts by weight of DM water |
| 1.8 | parts by weight of sodium persulfate |

### Procedure

Purge initial charge comprising water and emulsifiers in polymerization vessel with nitrogen and heat to 85° C. At initial charge 80° C. add stream 1a and stream 2 and allow to incipiently polymerize for 10 minutes. Then start stream 1a and stream 2. Add stream 1a over 135 minutes and stream 2 over 195 minutes. When stream 1a ends immediately add stream 1b over 45 minutes. This is followed by 30 minutes of supplementary polymerization.

Residual monomers are then removed by customary chemical or physical deodorization. After cooling to room temperature, the dispersion is adjusted to pH 8 with about 6.5 parts by weight of triethylamine.

The dispersion obtained has a solids content of about 40%. It forms a film which is free of gel specks and hard and brittle after complete drying. The glass transition temperature is found to be 27° C. and there is only a suggestion in the DSC diagram of a second glass transition stage in the region of 100° C. The size of the dispersion particles is below 150 nm. The Brookfield viscosity of the dispersion is in the range from 50 to 150 mPa.s.

### EXAMPLE5

| Initial charge | |
|---|---|
| comprising | |
| 300.0 | parts by weight of DM water |
| 30.0 | parts by weight of a seed latex |
| | (30% in water; particle size 20-40 nm) |
| Feed stream 1a: | |
| 500.0 | parts by weight of DM water |
| 2.4 | parts by weight of sodium pyrophosphate |
| 9.6 | parts by weight of di(2-ethylhexyl) |
| | succinate sulfonate, 50% in water |
| 17.1 | parts by weight of sodium lauryl ether |
| | sulfate (with 3-7 EO) 28% in water |
| 24.0 | parts by weight of acrylamide 50% in water |
| 9.0 | parts by weight of acrylic acid |
| 492.0 | parts by weight of methyl methacrylate |
| 390.0 | parts by weight of n-butyl acrylate |
| Feed stream 1b: | |
| 200.0 | parts by weight of DM water |
| 3.2 | parts by weight of di(2-ethylhexyl) |
| | succinate sulfonate, 50% in water |
| 8.6 | parts by weight of sodium lauryl ether |
| | sulfate (with 3-7 EO) 28% in water |
| 9.0 | parts by weight of acrylic acid |
| 288.0 | parts by weight of methyl methacrylate |
| Feed stream 2: | |
| 150.0 | parts by weight of DM water |
| 3.6 | parts by weight of sodium persulfate |

### Procedure

Purge initial charge in polymerization vessel with nitrogen and heat to 85° C. Then start stream 1a and stream 2. Add stream 1a and part of stream 2 over 135 minutes. After stream 1a ends wait 30 minutes and then add stream B over 45 minutes and the rest of stream 2 over 60 minutes. This is followed by 30 minutes of supplementary polymerization.

Residual monomers are then removed by customary chemical or physical deodorization. After cooling to room temperature, the dispersion is adjusted to pH 7.5 with about 7.5 parts by weight of 25% ammonia solution.

The dispersion obtained has a solids content of about 40%. It forms a film which is free of gel specks and hard and brittle after complete drying, a glass transition temperature is found at 28° C. and there is a second glass transition stage at 112° C. The size of the dispersion particles is below 180 nm. The Brookfield viscosity of the dispersion is less than 100 mPa.s.

### EXAMPLES 5a to 5c

Examples 5a, 5b, 5c are dispersions prepared similarly to Example 5 (i.e., identical ingredients, identical polymerization times). The only variables changed were the monomer lineups of streams 1a (called step 1) and 1b (called step 2):

5a) Step 1 corresponds to the composition: 20% of n-BA/20% of EA/33.5% of t-BMA/1% of AM/0.75 of AS

5a) Step 2 corresponds to the composition: 24% of t-BMA, 0.75 of AS.

5b) Step 1 corresponds to the composition: 20% of n-BA/15% of EA/38.5% of MMA/1% of AM/0.75 of AS

5b) Step 2 corresponds to the composition: 24% of MMA, 0.75 of AS

5c) Step 1 corresponds to the composition: 20% of n-BA/15% of EA/38.5% of MMA/1% of AM/0.75 of AS

5c) Step 2 corresponds to the composition: 16% of t-BMA/8% of n-BMA, 0.75% of AS

Examples 5a to 5c dry into brittle films having a distinctly visible glass transition stage in the range from 25 to 35° C. and a second, usually only suggested stage in the range from 80 to 120° C.

Sum total of steps 1 and 2 in each case 100%

Abbreviation of monomers: n-BA=n-butyl acrylate; EA=ethyl acrylate; MMA=methyl methacrylate; AM=acrylamide; AS=acrylic acid; t-BMA=tertiary butyl methacrylate

### EXAMPLE6

| Initial charge | |
|---|---|
| comprising | |
| 800.0 | Parts by weight of DM water |
| 27.2 | Parts by weight of a seed latex |
| | (30% in water; particle size 20-40 nm) |
| 12.0 | Parts by weight of ethylhexyl thioglycolate |
| Feed stream 1a: | |
| 500.0 | Parts by weight of DM water |
| 2.4 | Parts by weight of sodium pyrophosphate |
| 10.8 | Parts by weight of di(2-ethylhexyl) |
| | succinate sulfonate, 50% in water |
| 6.4 | Parts by weight of sodium lauryl ether |
| | sulfate (with 3-7 EO) 28% in water |
| 24.0 | Parts by weight of acrylamide 50% in water |
| 9.0 | Parts by weight of acrylic acid |
| 522.0 | Parts by weight of methyl methacrylate |
| 360.0 | Parts by weight of n-butyl acrylate |
| Feed stream 1b: | |
| 200.0 | Parts by weight of DM water |
| 3.6 | Parts by weight of di(2-ethylhexyl) |
| | succinate sulfonate, 50% in water |
| 2.1 | Parts by weight of sodium lauryl ether |
| | sulfate (with 3-7 EO) 28% in water |
| 9.0 | Parts by weight of acrylic acid |
| 288.0 | Parts by weight of methyl methacrylate |
| Feed stream 2: | |
| 200.0 | Parts by weight of DM water |
| 3.6 | Parts by weight of sodium persulfate |

### Procedure

Purge initial charge in polymerization vessel with nitrogen and heat to 85° C. Then start stream 1a and stream 2. Add stream 1a and part of stream 2 over 135 minutes. After stream 1a ends wait 30 minutes and then add stream B over 45 minutes and the rest of stream 2 over 60 minutes. This is followed by 30 minutes of supplementary polymerization.

Residual monomers are then removed by customary chemical or physical deodorization. After cooling to room temperature, the dispersion is adjusted to pH 7.5 with about 10 parts by weight of triethylamine.

The dispersion obtained has a solids content of about 40%. It forms a film which is free of gel specks and hard and brittle after complete drying, a glass transition temperature is found at 31° C and there is no sign of a second glass transition stage. The size of the dispersion particles is below 180 nm. The Brookfield viscosity of the dispersion is less than 100 mPa.s.

### Preparation of Top Coats, Coating Construction

A. Top Coat for Furniture Leather

The top coat utilizes 500 parts by weight of binder (40%), 500 parts by weight of water with 30 parts by weight of isocyanate crosslinker (organic solution of a modified aliphatic polyisocyanate; commercial BASF product: Astacin® Härter CN in 30% solvent) and the system is adjusted to spray viscosity with about 4 parts by weight of a thickener (e.g., Lepton Paste VL 1:1 in butylglycol).

The commercial product Lepton® Paste VL from BASF AG is a polyurethane in water/solvent of the type customarily used as a viscosity regulator for finish systems in the leather industry.

The viscosity of the aqueous top coat should amount to 24 efflux seconds from a Ford cup nozzle 4.

A single spray coat is applied. Further operations: milling, kiss plate at 80° C.

### Undercoat Construction

The starting material to be protected must generally be the surface of a cattlehide leather crust onto which a colored base coat was applied by twofold roll coating using a 20 lines per cm gravure.

Base coating formulation consisting of 150 parts by weight of Lepton Black N (this commercial product from BASF AG is a finely divided, aqueous pigment formulation having an anionic charge; with small amounts of protective colloids; free of caseine and other filming binders), 125 parts by weight of Lepton® Filler CEN (the commercial product Lepton Filler CEN from BASF AG is a filling and antistick agent for the base coating of soft, natural leathers. Aqueous dispersion of fatty acid ester, protein and inorganic filler, solids content: about 25%), 50 parts by weight of Eukesol Ölgrund from BASF AG (cationic oil emulsion with 45% water content as base coating agent for leather), 50 parts by weight of water, 200 parts by weight of a soft, hiding acrylate binder, 100 parts by weight of a soft, deeply penetrating acrylate binder, 20 parts by weight of Amollan® VC (commercial product from BASF AG, high performance flow agent for processing viscous finishing batches on the press in parallel motion. Used in combination with Amollan® E from BASF AG), 10 parts by weight of Amollan® E and x parts by weight of the previously described thickener to obtain a viscosity of about 60″ in Ford cup nozzle 6.

B. Top Coat for Shoe Upper Leather:

A typically elegant, lightly delustered top coat formulation with a pleasant hand for shoe upper leather consists of 150 parts by weight of acrylate/methacrylate binder (40%), 150 parts by weight of delusterant (30%, aliphatic polyester urethane with an inorganic delusterant; BASF commercial product: Astacin® Mattierung Mass.), 50 parts by weight of wax emulsion (12% aqueous wax dispersion as filling and hand agent; BASF commercial product: Lepton® Filler H) without or with up to 30 parts by weight of isocyanate crosslinker (organic solution of a modified aliphatic polyisocyanate; BASF commercial product: Astacin Härter CN in 30% solvent).

C. Top Coat for Apparel Leather

The top coat utilizes 200 parts by weight of binder (40%), 300 parts by weight of water, 30 parts by weight of wax emulsion (12% aqueous wax dispersion as filling and hand agent; BASF commerical product: Lepton® Filler H) with 10 parts by weight of isocyanate crosslinker (organic solution of a modified aliphatic polyisocyanate; BASF commercial product: Astacin Harter CN in 30% solvent) and the system is adjusted to spray viscosity with x parts of a thickener (e.g., about 2 parts by weight of Lepton Paste VL.

The commercial product Lepton Paste VL from BASF AG is a polyurethane in water/solvent of the type customarily used as a viscosity regulator for finish systems in the leather industry.

The viscosity of the aqueous top coat should amount to 24 efflux seconds from a Ford cup nozzle 4.

The coat is sprayed on twice. Further operations: plating 120° C./20 bar, milling, plating 120° C./10 bar.

### Undercoat Construction

The top coat is sprayed onto a base coat of the following composition for example:

Mixture of 80 parts by weight of Lepton Black N (finely divided aqueous pigment preparation with anionic charge; with small amount of protective colloids; free of caseine and other filming binders), 100 parts by weight of Eukesol Ölgrund (cationic oil emulsion with 45% water content as base coating agent for leather), 100 parts by weight of wax emulsion (12% aqueous wax dispersion as filling and hand agent; BASF commercial product: Lepton® Filler H), 450 parts by weight of water, 70 parts by weight of a 20% aqueous polyurethane dispersion; which improves the adhesion of the applied layers even to a hydrophobicized or greasy surface without impairing the hydrophobicization (Astacin® Grund UH from BASF AG), 80 parts by weight of a soft, cold flexible acrylate binder, 150 parts by weight of a soft, high hiding acrylate binder, applied by spraying 3×.

Performance Testing

The leathers were tested against relevant European standards or quality guidelines of the German trade associations. The following performance norms apply:

a) For furniture leather according to print European standards 13336 part 1 (1998):

| Rubfastness | Cycles/gray scale | Cycles/gray scale |
|---|---|---|
| (VESLIC rub tester) | Wet | Dry |
| to DIN 53 339: | 250×/>=3 | 500×/>=4 |
| Flexing endurance | Wet | Dry |
| (flexometer) | | |
| to DIN 53 351: | | 20 000 |

b) For shoe upper leather according to quality guidelines of the German trade associations:

| Rubfastness | Cycles/gray scale | Cycles/gray scale |
|---|---|---|
| (VESLIC rub tester) | wet | dry |
| to DIN 53 339: | 50×/>=3 | 50×/>=3 |
| Flexing endurance | wet | dry |
| (flexometer) | | |
| to DIN 53 351: | 10 000 | 50 000 |

c) For apparel leather EC leather institute, specification commission:

| Rubfastness | Cycles/gray scale | Cycles/gray scale |
|---|---|---|
| (VESLIC rub tester) | wet | dry |
| to DIN 53 339: | 20×/>=4 | 50×/>=4 |
| Flexing endurance | wet | dry |
| (flexometer) | | |
| to DIN 53 351: | | 50 000 |

### USE EXAMPLE 1a-B

Top coat of Example B, shoe upper leather, with 150 parts by weight of acrylate/methacrylate binder corresponding to Example 1a.

The test fastnesses exceed by far the values stipulated by German trade associations:

| Rubfastness | Cycles/gray scale | Cycles/gray scale |
|---|---|---|
| (VESLIC rub tester) | wet | dry |
| to DIN 53 339: | 400×/5 | 1000×/5 |
| Flexing endurance | wet | dry |
| (flexometer) | | |
| to DIN 53 351: | 20 000× (undamaged) | 50 000× (undamaged) |

### USE EXAMPLE 1b-Bv

Top coat according to varied Example B, shoe upper leather, with 150 parts by weight of acrylate/methacrylate binder corresponding to Example 1b. Except that 150 parts by weight of the binder of Example 1b were used and the crosslinking component (Astacin® Harter CN) was omitted from recipe B. The flexometer values dry remain at 50 000× (undamaged). The wet rubfastness decreases from 400×/5 to 100×/5. This is still far above the required level!

### USE EXAMPLES 2-B to 4-B

Top coat according to Example B, shoe upper leather, with 150 parts by weight of acrylate/methacrylate binder corresponding to Examples 2, 3 and 4.

The test fastnesses exceed by far the values stipulated by German trade associations:

| Rubfastness | Cycles/gray scale | Cycles/gray scale |
|---|---|---|
| (VESLIC rub tester) | wet | dry |
| To DIN 53 339: | 200×/5 | 1000×/5 |
| Flexing endurance | wet | dry |
| (flexometer) | | |
| to DIN 53 351: | 20 000× (undamaged) | 50 000× (undamaged) |

The wet rubfastnesses reach at least 200× in all runs without any damage being observed.

### USE EXAMPLE 5-A

Top coat according to Example A, buffed furniture leather, with 500 parts by weight of acrylate/methacrylate binder corresponding to Example 5.

All quality criteria for furniture leather according to print European standards 13336 part 1 (1998) are fulfilled.

### USE EXAMPLE 5-C

Top coat according to Example C, apparel leather, with 200 parts by weight of acrylate/methacrylate binder corresponding to Example 5.

The test criteria for apparel leather EC leather institute, specification commission, were exceeded by far:

| Rubfastness | | |
|---|---|---|
| (VESLIC rub tester) | Cycles/gray scale | Cycles/gray scale |
| to DIN 53 339: | wet | dry |
| | 300×/5 | 1000×/5 |
| Flexing endurance | wet | dry |
| (flexometer) | | |
| to DIN 53 351: | | 50 000× |

### USE EXAMPLES 5a-C to 5c-C

Top coat according to Example C, apparel leather, with 200 parts by weight of acrylate/methacrylate binder corresponding to Examples 5a to 5c.

The test criteria for apparel leather EC leather institute, specification commission, were again exceeded by far. All wet rubfastnesses are above 150×/5, usually even, as in the case of Example 5-C, at 300×/5. All tested tops remained undamaged up to 50 000× in the dry flexing endurance test. The dry rub values are also far above the required level.

Comparison with Nitrocellulose Coatings

The dispersion of Example 5 was tested in test recipe A for furniture leather and compared with two customary nitrocellulose emulsion coatings. The commercial products Corial® EM Finish G and Corial® EM Finish KN from BASF AG were used.

The samples are very similar with regard to luster and hand. Similarly, the flexometer values dry are the same high level for all samples at 50 000× without damage and 20 000× wet. The nitrocellulose coatings are distinctly worse in the wet rubfastnesses. Whereas Corial® EM Finish G still achieves a wet rubfastness of 80×/4, the value for Corial® EM Finish KN is only 20×/4-5. The values for the inventive dispersion in the above-specified recipe are 250×/3.

On adding 20 parts by weight of BASF product Lepton® Wachs WA (specific combination of silicones and auxiliaries) to test recipe A, the value improves to 300×/4.

The dispersion of Example 6 was directly compared with two customary nitrocellulose emulsion coatings (same coating weight on shoe upper leather). The commercial products Corial® EM Finish G and Corial® EM Finish KN from BASF AG were used. The coating with the dispersion on shoe upper leather (top coat consisting of 200 parts by weight of binder, 300 parts by weight of water, 30 parts by weight of Lepton Filler H, 0 or 15 parts by weight of Astacin Harter CN, 9 parts by weight of Lepton Paste VL, 100 parts by weight of water, sprayed 2×, plating at 80° C./50 bar) exhibits a pleasant, happy hand. Appearance and luster are very similar to the emulsion lacquers. The hand is more pleasant than in the case of the NC lacquer. Good fastnesses are obtained even without the crosslinker. The wet rubfastness achieved without crosslinker is 80×/5 (undamaged). When the top coat is crosslinked, the wet rubfastness achieved is 300×/5 (undamaged), while the dry flex values of 50 000× and wet flex values of 20 000× are okay. The wet flex samples of 20 000× with the nitrocellulose lacquers, however, already exhibit severe damage.

We claim:

1. A leather top coating composition comprising
(a) from 20 to 60% by weight of at least one dispersed copolymer A formed from
(a1) from 40 to 70% by weight of at least one ester A1 of methacrylic acid with C₁₋₈-alkanols,
(a2) from 25 to 60% by weight of at least one ester A2 of acrylic acid with C₁₋₈-alkanols,
(a3) from 0 to 3.5% by weight of at least one C₃-C₆ α,β-monoethylenically unsaturated carboxylic acid A3,
(a4) from 0 to 4% by weight of at least one further auxiliary monomer A4 such as hydroxypropyl acrylate, ureidomethacrylate, acrylamide, methacrylamide, N-methylolacrylamide, N-methylolmethacrylamide, A1, A2 and optionally A3 and/or A4 adding up to a total of 100% by weight,
(b) at least 40% by weight of water (B),
(c) from 0 to 40% by weight of polyurethane top coating composition C for leather,
A, B and optionally C adding up to a total of 100% by weight and the top coating composition being free of plasticizers and synthetic waxes.

2. A top coating composition as claimed in claim 1, wherein said copolymer A is constructed of
(a1) from 55 to 70% by weight of at least one ester A1 of methacrylic acid with C₁₋₈-alkanols or mixtures of these methacrylates,
(a2) from 25 to 40% by weight of at least one ester A2 of acrylic acid with C₁₋₈-alkanols,
(a3) from 0.5 to 2% by weight of at least one C₃-C₆ α,β-monoethylenically unsaturated carboxylic acid A3,
(a4) from 0.1 to 2% by weight of one further auxiliary monomer such as hydroxypropyl acrylate, ureidomethacrylate, acrylamide, methacrylamide, N-methylolacrylamide, N-methylolmethacrylamide or a mixture thereof.

3. A top coating composition as claimed in claim 1, further comprising from 0 to 15% by weight of a polyurethane crosslinker D based on polyfunctional isocyanates and/or from 0 to 15% by weight of an aziridine crosslinker E based on trimethylolpropane tris(beta-aziridino)propionate.

4. A top coating composition as claimed in claim 1, free of crosslinkers.

5. The use of copolymers A formed from
(a1) from 40 to 70% by weight of at least one ester A1 of methacrylic acid with C₁₋₈-alkanols,
(a2) from 25 to 60% by weight of at least one ester of acrylic acid with C₁₋₈-alkanols,
(a3) from 0 to 3.5% by weight of at least one C₃-C₆ α,β-monoethylenically unsaturated carboxylic acid A3,
(a4) from 0 to 4% by weight of at least one further auxiliary monomer A4 such as hydroxypropyl acrylate, ureidomethacrylate, acrylamide, methacrylamide, N-methylolacrylamide, N-methylolmethacrylamide,
A1, A2 and optionally A3 and/or A4 adding up to a total of 100% by weight,
as a top coating composition for leather, whereby the copolymer A has two DSC transitions in the ranges from 20 to 40° C. and from 60 to 120° C. when operating according to a two step procedure.

6. The use of top coating compositions as claimed in claim 1 for surface treatment of leather.

7. A process for preparing top coating compositions as claimed in claim 1, which comprises emulsion or step polymerizing said monomers A1, A2 and optionally A3 and/or A4 to form an aqueous dispersion of said copolymer A and optionally admixing with said polyurethane top coating composition C.

8. Leather topcoated with copolymers A formed from
(a1) from 40 to 70% by weight of at least one ester A1 of methacrylic acid with C₁₋₈-alkanols,
(a2) from 25 to 60% by weight of at least one ester Ad of acrylic acid with C₁₋₈-alkanols,
(a3) from 0 to 3.5% by weight of at least one C₃-C₆ α,β-monoethylenically unsaturated carboxylic acid A3,
(a4) from 0 to 4% by weight of at least one farther auxiliary monomer A4 such as hydroxypropyl acrylate, ureidomethacrylate, acrylamide, methacrylamide, N-methylolacrylamide, N-methylolmethacrylamide,
wherein A1, A2 and optionally A3 and/or A4 adding up to a total of 100% by weight, whereby the copolymer A has two DSC transitions in the ranges from 20 to 40° C. and from 60 to 120° C. when operating according to a two step procedure.
